(19) United States
(12) Patent Application Publication
(10) Pub. No.: US 2010/0205629 A1
(43) Pub. Date: Aug. 12, 2010

(54) Device and method for provisioning or monitoring cable services

(75) Inventor: Peter Snawerdt, West Melbourne, FL (US)

Correspondence Address: Davidson, Davidson & Kappel, LLC, 485 7th Avenue, 14th Floor, New York, NY, 10018, US

(73) Assignee: Outerbridge Networks, LLC, West Melbourne, FL (US)

(21) Appl. No.: 12/799,200

(22) Filed: Apr. 20, 2010

Related U.S. Application Data
(63) Continuation of application No. 11/725,766, filed on Mar. 20, 2007.
(60) Provisional application No. 60/784,122, filed on Mar. 20, 2006.

(51) Int. Cl. H04N 7/16

(52) U.S. Cl. 725/26

(57) ABSTRACT

A device for controlling cable signals between a network cable and drop cables to customers includes an input for receiving cable signals; a first output connector for sending the cable signals to a first customer; a second output connector for sending the cable signals to a second customer; electronics selectively connecting the input to the first output connector so as to permit or deny a provision of the cable signals to the first customer, and selectively connecting the input connector to the second output connector to permit or deny provision of the cable signals to the second customer; and a cable modem, the cable modem capable of receiving instructions via the input and sending the instructions to the microprocessor and sending information via the input. A device for connecting between a cable tap and drop cables is also provided, as are various methods and cable systems.

This claims priority to U.S. Provisional Application No. 60/784,122 filed Mar. 20, 2006 and hereby incorporated by reference herein.

The present invention relates to cable television (CATV) systems, and more specifically to provisioning and receiving information about CATV services.

### BACKGROUND INFORMATION

Bi-directional CATV networks typically require service provisioning at the signal tap. The services provided are always available at all times at the signal tap in current cable systems. Thus, to disconnect the service from a customer requires a maintenance action at the signal tap to physically disconnect the cable linking the customer premises to the feed. To re-establish the service to a customer requires a maintenance action to connect the customer premises cable to the feed. These maintenance actions are often subcontracted by the cable company to a local cable maintenance service provider. Cable operators designate a team of technicians to audit at least 10% of the contractor's disconnect work. Cable operators have experienced unscrupulous subcontractors who report that the maintenance action to disconnect a cable to remove a customer from the network has been complete when, in fact, it has not. When a new customer takes over this customer premises, they will be already connected to the cable signal without having to pay for it. Unfortunately for the cable service provider, this type of theft can only currently be determined through a physical tap audit. Additionally, if a customer figures out how to connect him/her self to the cable feed, the cable signal can be ‘stolen’—again resulting in lost revenue to the cable service provider.

Cable operators experience chums rates up to 60% of its subscribers' base each year highlighting the significant number of transactions that are disconnected daily and the associated embedded cost to fulfill those disconnects. When those customers are disconnected appropriately, a significant number of those customers return as subscribers. When subscribers are not disconnected appropriately, cable operators lose access to those customers as new subscribers and the associated revenue.

Disconnection of service is generally driven by slow or non-paying subscribers and those subscribers who move out of the cable operator's system. Today, those non-pay subscribers are soft disconnected around day 60 from when the bill is due. This applies to only those customers with set top boxes (STB) in the home. From the local office the cable operator is able to disable the STB with a remote command and premium services like HBO and Showtime are not available. Most customers are educated about the vulnerabilities of the cable system and know that if they disconnect the coax cable from the back of the STB and connect directly to the their television, they will have the basic programming tier, about 80 analog channels, until the service is hard disconnected by a technician. The reasons customers can continue to get the service is that the signal is always live at the cable tap irrespective of the condition of the box.

Addressable taps permitting CATV service providers to turn on and off each subscriber at the tap level have been in limited use since 1983. These devices are an attempt to eliminate the need to manually connect and disconnect service by automatically switching the signal being delivered to each subscriber port on or off. The signal used to ‘address’ the tap is an FM modulated RF signal in the unused portion of the cable frequency spectrum (usually around 100 MHz). This communication capability, however, is only one way: from the control unit to the tap. Thus, there is no verification from the tap electronics that the command was received and acted upon, thus, eliminating the possibility of an electronic audit. Because these taps have the cable connected to them at all times, it is also difficult to physically audit them to make sure that customers are connected properly. Therefore, over time after the installation of the addressable tap, disconnects would be missed based upon the reliability of the communications media and equipment simply because the addressable tap cannot confirm the status of the connection for each port. It is assumed that connections would not be missed because customers would call in due to a lack of service that they were paying for. Thus, the cable operator is left with an unverifiable and unconfirmed connection status for its non-customers with an erosion of revenue being the result. In addition, cable television offerings have increased in complexity and addressable taps in the marketplace have limited ability (or no ability) to provision services meaning that a manual operation often must be done on the output of the addressable tap to add filtering customized to the service being provisioned. Addressable taps also represent a “re-build” of the existing network—they are not designed to be an add-on product. For these reasons, addressable taps have not gained wide range acceptance in the cable television market.

### SUMMARY OF THE INVENTION

The present invention provides a device for controlling cable signals between a network cable and drop cables to customers comprising:
an input for receiving cable signals;
a first output connector for sending the cable signals to a first customer;
a second output connector for sending the cable signals to a second customer;
a circuit selectively connecting the input to the first output connector so as to permit or deny a provision of the cable signals to the first customer, and selectively connecting the input connector to the second output connector to permit or deny provision of the cable signals to the second customer; and

a cable modem, the cable modem capable of receiving instructions via the input and sending information via the input.

The present invention also provides a device for connecting a cable signal tap and drop cables to customers comprising:
a first input connector for receiving cable signals from a first port of the signal tap;
a second input connector for receiving the cable signals from a second port of the signal tap;
a first output connector for sending the cable signals to a first customer;
a second output connector for sending the cable signals to a second customer; and a circuit connecting the first input connector to the first output connector and connecting the second input connector to the second output connector.

The present invention also provides a control system for a cable network comprising:

a plurality of electronically-controlled devices, each located between a network cable and a plurality of drop cables for customers and each having an a media access control address, and

a server for controlling the electronically-controlled devices, the server selectively enabling provisioning of cable service to each customer.

The present invention also provides a system for monitoring a cable network comprising:

a plurality of electronically-controlled devices, each located between a network cable and a plurality of drop cables for customers and each having an a media access control address, and

a server for receiving information on the electronic devices, the information providing information on the status of cable services to each customer.

The present invention also provides a method for mapping a cable network comprising the step of sending information regarding the connection status of a plurality of drop cables from an off-premises cable modem.

The present invention also provides a method for updated an existing cable network comprising attaching controllable switching devices to existing cable signal taps.

### BRIEF DESCRIPTION OF THE DRAWINGS

One preferred embodiment of the present invention will be described with respect to the following drawings in which:

FIG. 1 shows a system according to one embodiment of the present invention;

FIG. 2 shows a preferred embodiment of the device of the present invention using a controller module separate from a switch module;

FIG. 3 shows a further embodiment of an integrated device of the present invention;

FIG. 4 shows a block diagram of one embodiment of the controller module of the present invention with a single output connector powering a switch;

FIG. 5 shows a block diagram of a controller module of the present invention with two output connectors;

FIG. 6 shows different types of AC power that may exist in the cable network;

FIG. 7 shows details of the input connector, signal splitter and AC-DC converter of the controller module of FIG. 4;

FIG. 8 shows details of temperature sensor, microprocessor support electronics, microprocessor and DC-DC converter of the controller module of FIG. 4;

FIG. 9 shows details of the communications controller of the controller module of FIG. 4;

FIG. 10 shows details of the serial transmitter/receiver and output connectors of the controller module of FIG. 4;

FIG. 11 shows one embodiment of an eight port switch module;

FIG. 12 shows details of the input connectors, signal splitters, SPDT switches and output connectors of the FIG. 11 embodiment;

FIG. 13 shows details of the SP4T switches and power sensors of the FIG. 11 embodiment;

FIG. 14 shows details of the microprocessor of the FIG. 11 embodiment;

FIG. 15 shows details of the DC-DC converters of the FIG. 11 embodiment;

FIG. 16 shows details of the serial power connectors of the FIG. 11 embodiment;

FIG. 17 shows details of the serial transmitter/receiver of the FIG. 11 embodiment; and

FIGS. 18 and 19 show details of the support electronics of the FIG. 11 embodiment.

### DETAILED DESCRIPTION

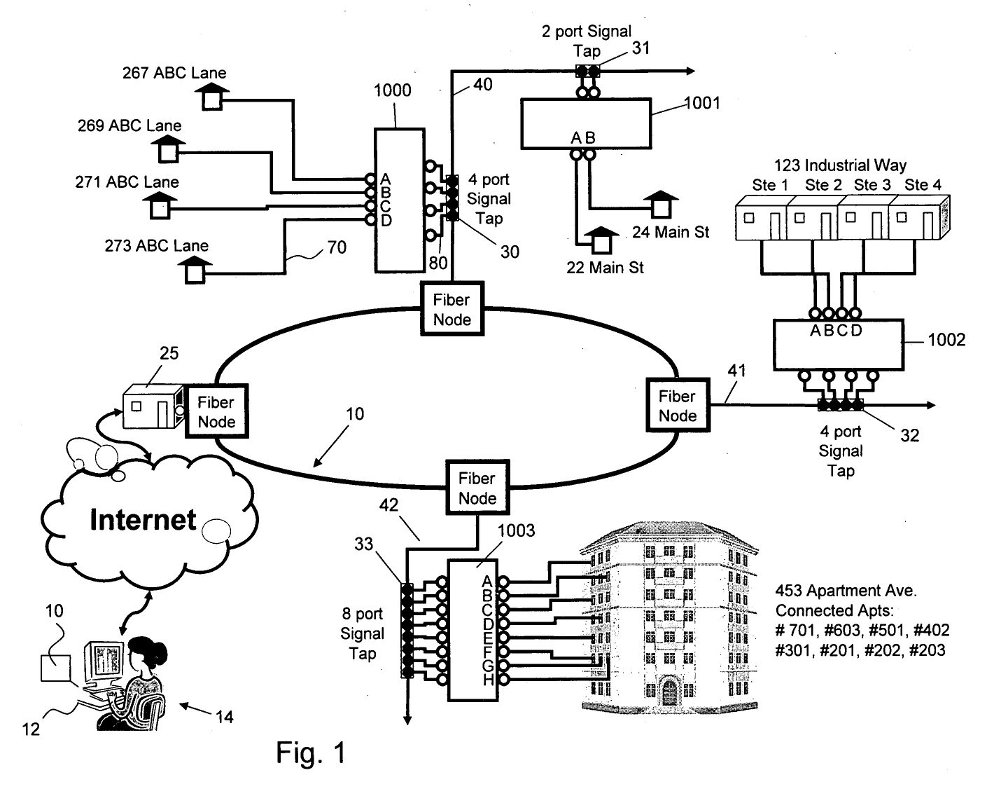

FIG. 1 shows schematically one embodiment of the present invention showing a hybrid fiber coax cable network architecture having a head end 25 connected to a fiber optic loop 20, and branched network cables 40, 41, 42. Switching devices 1000, 1001, 1002, 1003 of the present invention located between taps 30, 31, 32, 33 of the network cables 40, 41, 42. In this example, each switching device 100 is known uniquely by service monitoring and provisioning software 10 in a server 12 of a remote operations center 14.

Server 12 may also have a memory storing customer information. For example, a database may store the following information:

Device 1000 port A is connected to customer premise 267 ABC Lane

Device 1000 port B is connected to customer premise 269 ABC Lane

Device 1000 port C is connected to customer premise 271 ABC Lane

Device 1000 port D is connected to customer premise 273 ABC Lane

Device 1001 port A is connected to customer premise 22 Main St

Device 1001 port B is connected to customer premise 24 Main St

Device 1002 port A is connected to customer premise 123 Industrial Way, Suite 1

Device 1002 port B is connected to customer premise 123 Industrial Way, Suite 2

Device 1002 port C is connected to customer premise 123 Industrial Way, Suite 3

Device 1002 port D is connected to customer premise 123 Industrial Way, Suite 4

Device 1003 port A is connected to customer premise 453 Apartment Ave, #701.

Device 1003 port B is connected to customer premise 453 Apartment Ave, #603

Device 1003 port C is connected to customer premise 453 Apartment Ave, #501

Device 1003 port D is connected to customer premise 453 Apartment Ave, #402

Device 1003 port E is connected to customer premise 453 Apartment Ave, #301

Device 1003 port F is connected to customer premise 453 Apartment Ave, #201

Device 1003 port G is connected to customer premise 453 Apartment Ave, #202

Device 1003 port H is connected to customer premise 453 Apartment Ave, #203

Each switching device 1000, 1001, 1002, 1003 can automatically provision each port as will be described, and this provisioning can be controlled by software 10 from the server 12 in center 14. The switching devices advantageously may be connected between existing signal taps and the drop cables 70 of customers using connector cables 80, and thus may be installed easily within existing cable networks.

Each switching device may have a unique identifier, and with the network database and the capability to uniquely address each port, service can be automatically provisioned to each location to reduce cable theft occurrence and reduce maintenance costs. Cable connects and disconnects can be automated. The system advantageously is compatible with existing cable network head-end software requiring only the provisioning of a MAC address for each switching device deployed. IP protocol signals can be used to communication between a cable modem in the switching device and the head end, which also may have a cable modem.

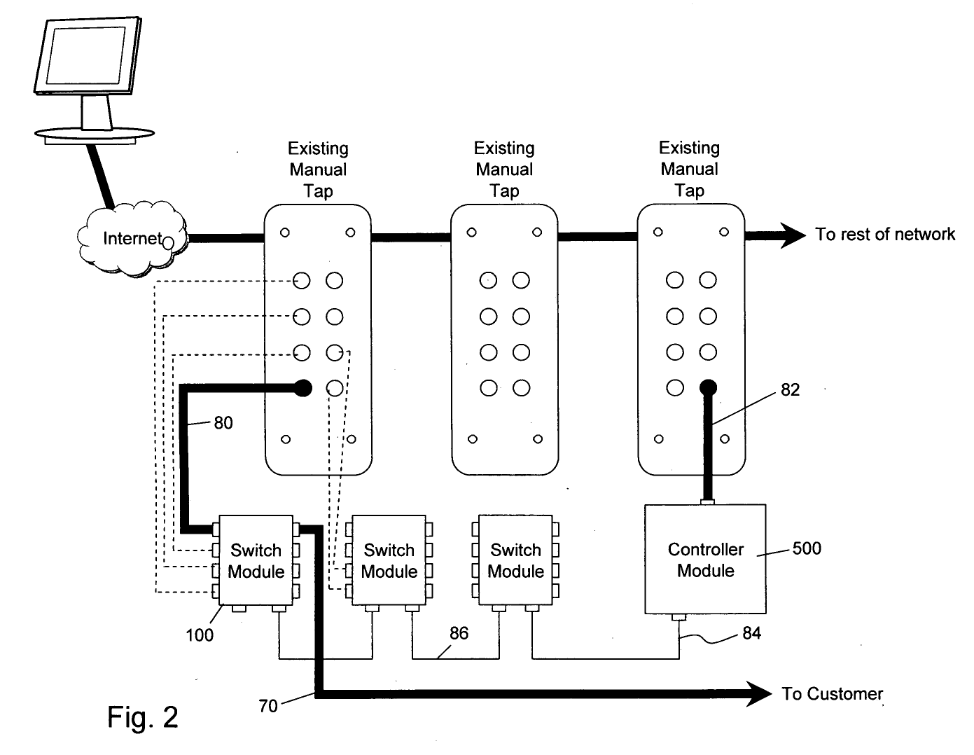

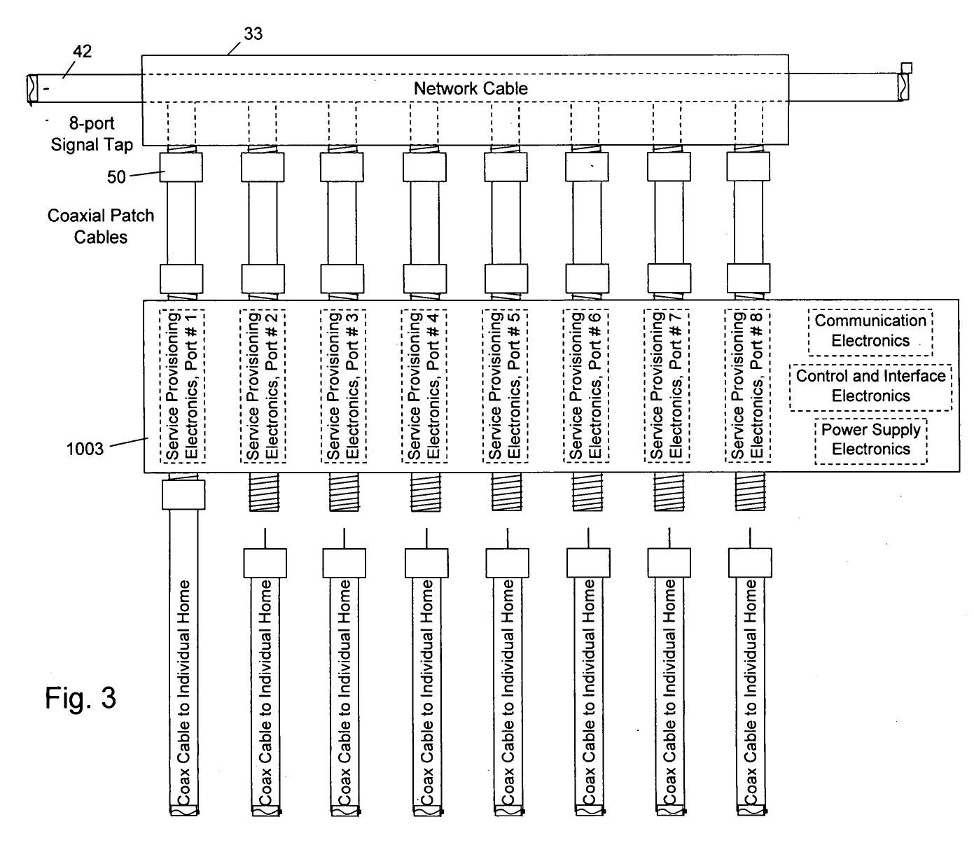

The switching devices 1000, 1001, 1002, 1003 are designed to be physically deployed alongside the signal taps 30, 31, 32, 33 in the cable network, although they could be integrated with tap technology and be used to replace signal taps or in new networks. Switching devices connect between the signal tap and customer premise as shown for example in FIG. 2 with a switch module/controller module configuration defining the switching device, or FIG. 3 with an 8-port signal tap switching device 1003. Connections can be made for example using locking connectors 50 to help ensure the integrity of the connections.

Software 10 permits changing the service state for a customer, so that via a graphical user interface an operator can choose the customer and change the service state via for example a GUI selection. The server 12 then sends a message via the cable network to the relevant switching device 1000 to 1003. The service states that could be chosen include that cable service is disconnected at the identified port or cable service is connected for all services at the identified port.

The switching devices 1000 also advantageously provide a cable provider the ability to map the cable network. The connection between a given port and customer premises is known and required to be known in order to provision services correctly, and can be communicated to the head end at predetermined times or based on queries from the software 10. This knowledge can be a large advantage when determining the cause of inadvertent service disruptions or quickly restoring service following disruption due to weather or other catastrophic events. As an example, if, in a HFC network, a certain number of switching devices fail to report connectivity following a hurricane, but others upstream along the same cable branch do report, the cause of reporting failure is likely due to a cable break between two service cabinet locations along the network branch. As an additional example, if a customer reports a cable outage at their home, but the switching device, which is off-premise, reports a connection, the likely cause of cable disconnect is either in the customer premise or a break in the cable between the switching device and the premise. In either case, detailed information regarding the cause of service disruption can be provided to the service technician resulting in a reduced time to return service and less cost to the cable provider to do so.

FIG. 2 shows one embodiment in which the switching device is implemented as a two-part expandable device, having a controller module 500, and a plurality of four-port switching modules 100. Controller module 500 can attach to an existing manual tap via a cable 82, which provides the controller module to the RF signal and power, and permits the controller module 500 to receive and send signals to the head end 25. Cable 84 can connect the controller module to switch modules 100, each capable of connecting to another switch module via extender cables 86. In this way a single controller module can control more than one switch module.

FIG. 3 shows an alternate embodiment in which the switch module and controller module are integrated. The present invention will be described however with reference to the FIG. 2 embodiment with separate switch and controller modules, which is advantageous in that it is expandable and the controller module can be used for other functions.

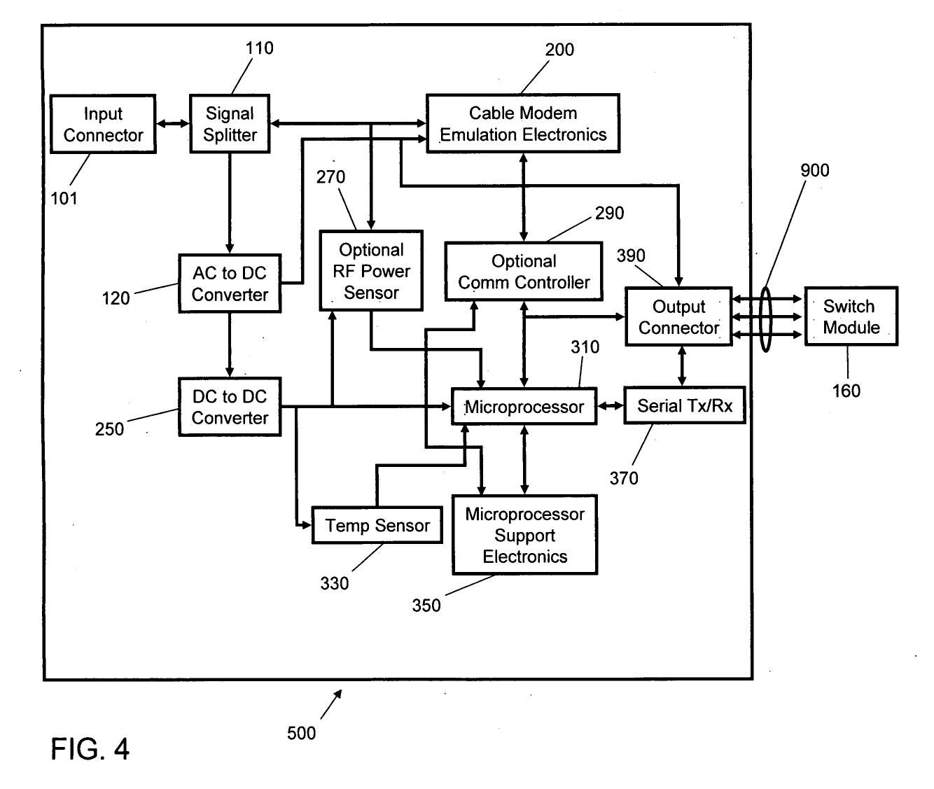

FIG. 4 shows a detailed block diagram of the controller module 500 with an attached, remote switch module 1000. The controller module 500 input connector 101 is a connector that is compatible with existing cable television network patch cables, such as an F connector jack. The input connector 101 is capable of passing AC power as well as the RF spectrum allocated within the cable network for modem operations (5 MHz to 50 MHz and 550 MHz to 850 MHz). The output of the input connector 101 carrying the composite RF+AC power signal feeds a signal splitter 110 designed to separate the AC signal and the RF signal. The AC signal is routed to an AC to DC converter circuit 120 to provide DC power for the controller module 500 and one or more switches 1000 while the RF signal is routed to an optional RF power sensor 270 and the cable modem emulation electronics 200. The signal splitter 110 is designed such that the AC power signal is heavily attenuated when viewed at the signal splitters' 110 RF port output and the RF signal is heavily attenuated when viewed at the signal splitters' 110 AC port output. The AC to DC converter 120 is designed to convert a 60V to 90V, 60 Hz AC square wave, quasi-square wave, or sine wave input to a DC voltage necessary to support the cable modem emulation electronics 200 and peripheral switch modules 1000, such as +12V DC. The resulting DC power signal is used to power various functions in the controller module 500 and switch modules 1000. The DC to DC converter 250 is designed to convert the output of the AC to DC converter 120 to an alternate voltage level compatible with TTL electronics assuming that the AC to DC converter 120 output voltage is incompatible with these devices. The optional RF power sensor 270 samples and measures the output power from the cable modem emulation electronics 200. The output of the optional RF power sensor 270 may be either in a digital form or an analog voltage. In the diagram of FIG. 4, the optional RF power sensor 270 output is assumed to be digital and is directly connected to the microprocessor 310 bus. If the output of the optional RF power sensor were an analog voltage, it would require connection to an analog to digital conversion port within the microprocessor 310 or to an external analog to digital converter whose digital output would then be connected to the microprocessor 310 bus. The RF power level measured by the optional RF power sensor 270 is useful diagnostic information for testing the controller module 500 and may be sent to the web based software 10, represented in FIG. 1, to use for diagnostic or other purposes.

The cable modem emulation electronics 200 offer the full functionality of a standard cable modem with respect to the cable network interface. However, the cable modem emulation electronics 200 are not necessarily required to support the full functionality required to connect to a standard personal computer. In FIG. 4, the cable modem emulation electronics 200 are connected to an optional communication controller 290. The optional communication controller 290 could be a universal serial bus (USB) controller or Ethernet controller as examples. This allows the freedom to either directly connect the cable modem emulation electronics 200 to the microprocessor 310 bus or through an optional communication controller 290. Existing cable modem systems are considered to be mature systems with respect to both hardware and software performance and reliability. Thus, connecting the microprocessor 310 through an optional communication controller 290 offers the advantage that existing cable modem technology may be used to implement the cable modem emulation electronics 200 function. Alternately, the cable modem emulation electronics 200 may be connected directly to the microprocessor 310 bus which has the advantage of eliminating unnecessary cable modem hardware functions used to support a personal computer interface with the potential penalty of increased software development.

The microprocessor 310 provides for a programmable device supporting the controller module 500 device tasks. Alternate to microprocessor 310, an application specific integrated circuit (ASIC) or other hardwired logic without software could be provided. The microprocessor 310 acts as the primary communication hub between the controller module 500 and the web-based software 10 of FIG. 2. Messages or data sent from the web-based software 10 of FIG. 1 to the controller module 500 are received by the microprocessor 310, decoded, acknowledged, and acted upon. Messages or data sent from the web-based software 10 of FIG. 1 may be commands, requests for status, downloads of updated software, or other requests and commands. Similarly, messages or data to be sent to web-based software 10 of FIG. 1 from the controller module 500 can be initiated by the microprocessor 310. Messages to the web-based software 10 of FIG. 1 may include the switch status for each output connector, temperature information or other diagnostic information, and maybe preset based on times or may be operated initiated.

The microprocessor support electronics 350 includes the power-up reset logic for the microprocessor 310, LED's, crystal oscillator circuits to provide a time reference for the microprocessor 310, digital memory, and other components. A temperature sensor 330 allows the microprocessor 310 to report the temperature environment of the controller module 500 to the web-based software 10 of FIG. 1.

The controller module 500 of FIG. 4 includes a serial transmit/receiver 370 for communication with switch modules 1000. The serial TX/RX 370 may be implemented as RS-232, RS-422, low voltage differential signaling (LVDS), or other communication technology. The purpose of the serial TX/RX 370 is to allow the controller module 500 to act as a transponder for peripheral devices such as the switch 1000 of FIG. 4. The output connector 390 of the controller module provides main DC power from the AC to DC converter 120 to peripheral devices, serial TX/RX 370 communication functionality, and digital signaling to and from the microprocessor 310. The controller module 500 may include more than one output connector 390 with the indicated functionality to control one or more switches 1000s. FIG. 4 shows a single output connector 390 for simplicity sake.

The switch module 1000 is connected to the controller module 500 through a cable 900. The cable 900 may be of any length compatible with the signaling requirements required for the serial TX/RX 370 function and the digital signaling requirement of the microprocessor 310 and internal digital components of the security device 1000. This allows the security device 1000 to be installed remotely from the controller module 500 or locally with the controller module 500 based upon customer installation desires. The cable 900 is attached to an input connector 1050 on the security device 1000 to electrically connect the security device 1000 to the controller module 500. The DC power lines in the cable 900 are routed to the electronic switch 1110 and a DC to DC converter 1070. The DC to DC converter 1070 is designed to convert the DC voltage of the supplied power to an alternate voltage level compatible with TTL electronics assuming that the voltage of the supplied power is incompatible with these devices.

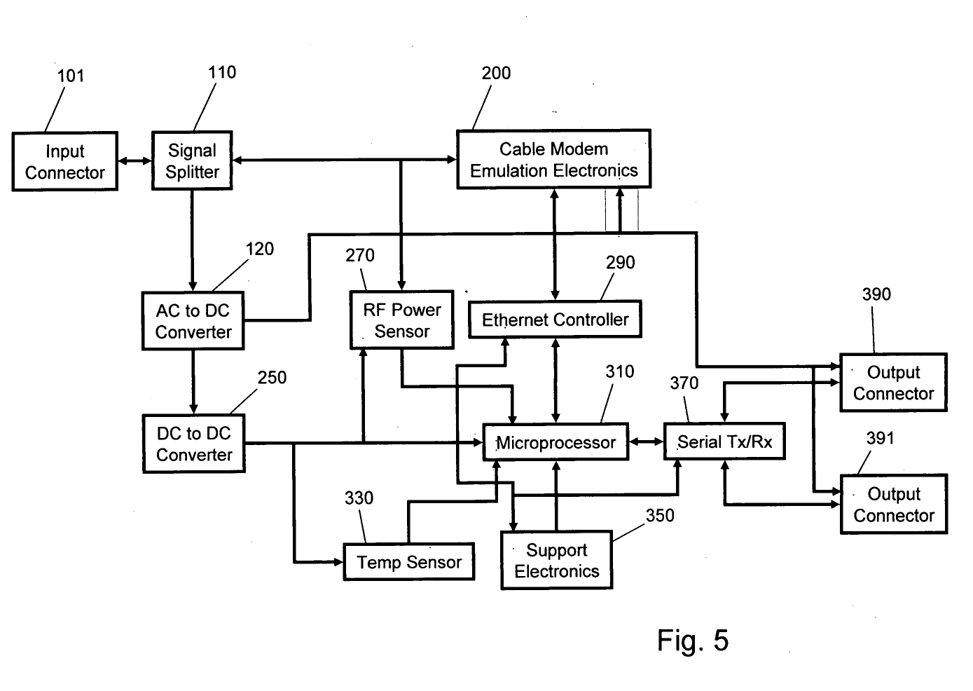

FIG. 5 shows a similar controller module 500, but with two output connectors 390 and 391. Thus one output connector could be used for one switch module 100 and the second for a second switch module in an alternate embodiment, so that two switch modules 100 are not necessarily connected in series as in FIG. 2.

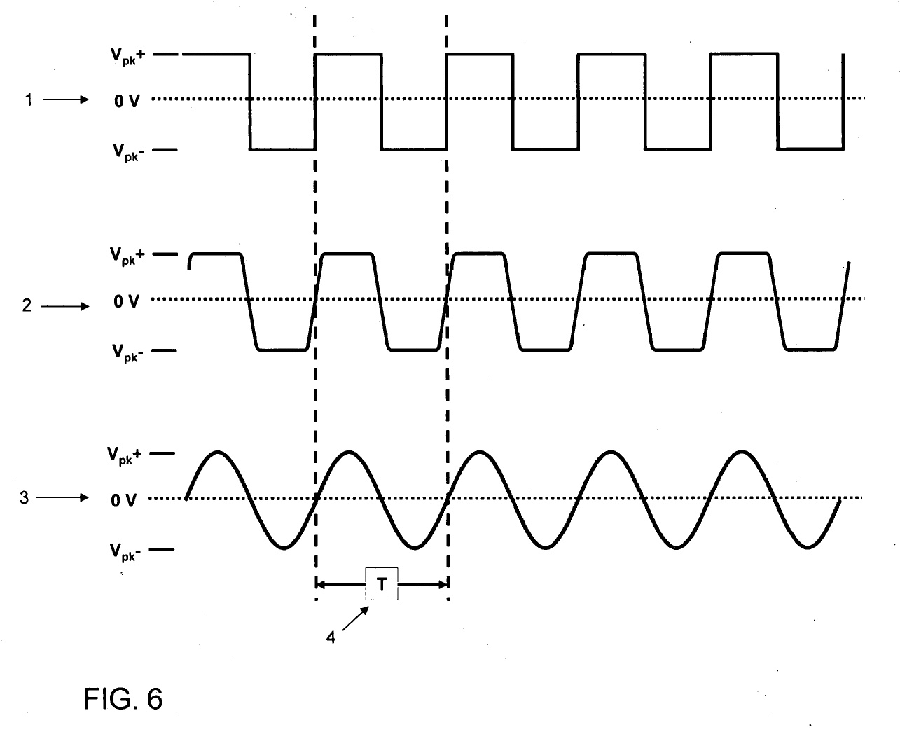

FIG. 6 shows square wave 1, quasi-square wave 2, and sine wave 3 representation of the different types of AC power that may exist in the cable network. The power in modern cable networks in the United States have voltages ranging from 60 VAC to 90 VAC at a 60 Hz cycle rate where the cycle rate is computed as 1/T in FIG. 5. These voltage levels represent the root-mean-squared voltage levels. For the square wave 1 of FIG. 5, the peak voltage is equal to the root mean squared voltage or Vₚₖ=Vᵣₘₛ. For the sine wave 3 of FIG. 5, the peak voltage is equal to \sqrt{2} times the root mean squared voltage or Vₚₖ=\sqrt{2}Vᵣₘₛ. The square wave 1 and sine wave 3 represent the minimum and maximum peak voltage bounds for the AC power in cable television networks. Thus, the minimum peak voltage would occur in a 60VAC system that uses a square wave 1 generator and the minimum peak voltage would be 60 V. The maximum peak voltage would occur in a 90 VAC system that uses a sine wave 3 generator and the maximum peak voltage would be 127.3 V.

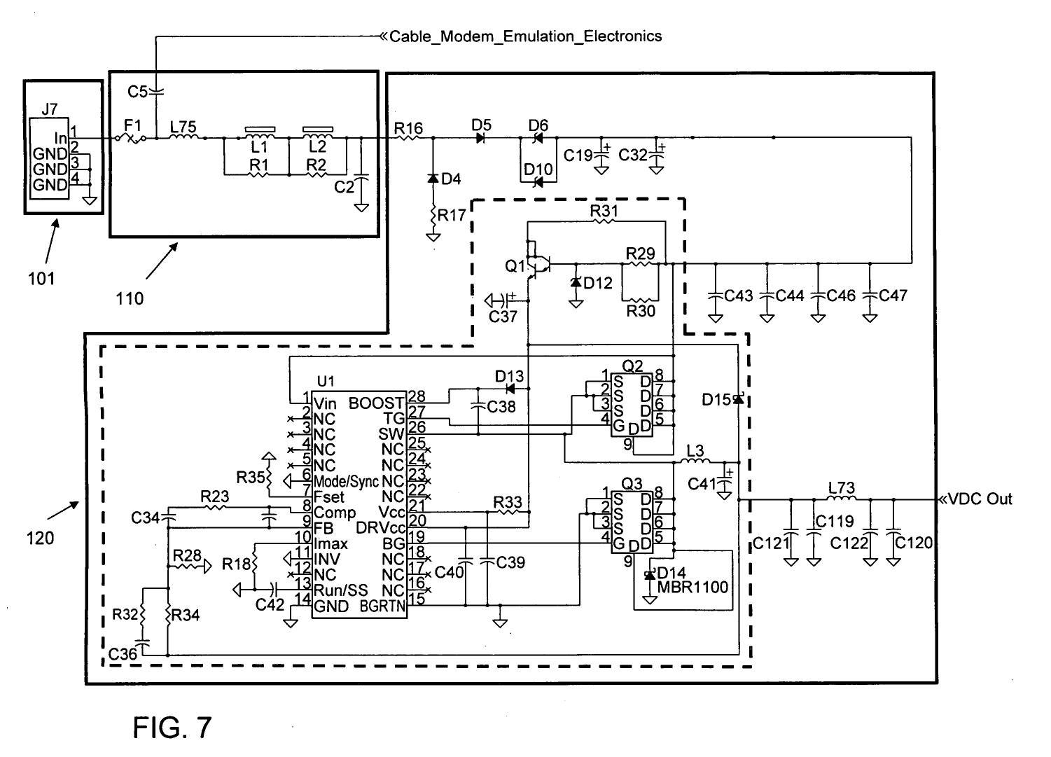

FIGS. 7 to 16 show a detailed schematic diagram of an instantiation of the present invention whereby one or more switch modules 100 are remotely controlled by a controller module. This particular instantiation utilizes a commercially available cable modem such as the Webstar DPC2100R2 series cable modem from Scientific Atlanta for the cable modem emulation electronics 200 of FIG. 4.

FIG. 7 is a detailed schematic of an instantiation of the input connector 101, signal splitter 110, and AC to DC Converter 120 of FIG. 4. Input connector 101 in this instantiation of the invention may include a printed circuit board mounted F connector with four ground connections and a single center conductor carrying the composite RF and AC power connector. The signal splitter 110 of FIG. 4 is comprised of the components F1, C5, L75, L1, L2, R1, R2, and C2. F1 is a positive temperature coefficient (PTC) fuse designed to cause an open circuit condition when a steady-state current flow through the device exceeds its specification. The purpose of including a PTC fuse at the controller module 500 input is to safeguard the network and installation locations against hazards due to potential short circuit conditions that may develop within the controller module 500 or the security device 1000. F1 is capable of handling up to approximately 130 peak volts, and is capable of passing the full spectrum of DC to 1 GHz, and should be chosen for over-current conditions exceeding the anticipated current draw of the controller module 500 and attached security devices 1000 or other peripherals.

The capacitor, C5, is chosen to present a low impedance to signals between 5. MHz and 850 MHz and a high impedance to the 60 Hz AC power signal and lower order harmonics if the power signal is a square wave 1 of FIG. 5 or quasi-square wave 2 of FIG. 5. The impedance, Z, of the capacitor, C5, is given by

$$Z = \frac{1}{2 * π * f * C5} \qquad Eq . 1$$

Where: π if the value pi which is equal to 3.141592 . . .

f is the frequency in hertz

C5 is the capacitance of the component, C5, in Farads

Z is the resulting impedance magnitude in Ohms

In addition to impedance considerations, the capacitor, C5, is also be capable handling potential high voltages on the cable line due to power transients or lightning strikes. It is also desirable for C5 to have a low effective series resistance and effective series inductance. If a suitable single capacitor cannot meet the designers' requirements two or more capacitors may be put in parallel with one another.

The components L75, L1, L2, R1, R2, and C2 in this embodiment are chosen to present a low impedance to the 60 Hz AC power signal and a high impedance to the RF signals between 5 MHz and 850 MHz. The components L75, L1, L2, R1, and R2 represent a distributed RF choke. Cable systems are 75Ω systems, so the composite impedance of the distributed RF choke should be at least greater than 750Ω over the 5 MHz to 850 MHz frequency range to avoid unnecessary insertion loss due to the presence of the RF choke. Inductive components such as L75, L1, and L2 have an effective capacitance between turns of the wire coil which produces a self capacitance that in combination with the inductance produces an LC resonance. For broadband applications such as this, the resonances often lie with the band of the RF signal. Reduction in the number of turns of the inductor can push any LC resonances above the passband, but this reduction will also result in a lower inductance limiting the effectiveness of the inductor at the low end (5 MHz) of the band. The distributed choke in the present invention overcomes these problems by having an inductor, L75, with a low number of turns with good rejection capabilities in the mid and upper frequencies of the RF signal band and resonances outside the band of the RF signal in series with inductors, L1 and L2, which have a higher number of turns for low frequency rejection. The impedance, Z, of the inductive components is given by

Z=2*π*f*L Eq. 2

Where: π if the value pi which is equal to 3.141592 . . .

f is the frequency in hertz

L is the inductance in Henry's

Z is the resulting impedance magnitude in Ohms

The resistors, R1 and R2, are in parallel with the inductors, L1 and L2, to reduce the Q of the LC resonance of the inductors which has the effect of dulling the response of any in-band resonances of L1 or L2. The capacitor, C2, is chosen to present a low impedance to signals between 5 MHz and 850 MHz to provide an RF path to ground on the power output leg of the signal splitter 110 of FIG. 4 and a high impedance to the 60 Hz AC power signal.

The components R16, D4, R17, D5, D6, D10, C19, C32, C43, C44, C46, and C47 half-wave rectify the 60 Hz AC power signal, reduce the peak voltage to the input voltage range of the switching regulation circuitry, and provides voltage hold-up during the negative voltage half-cycle of the AC power input. The resistor, R16, is used to help limit the in-rush currents at initial application of power. The diodes, D4 and D5, are used to create the half-wave rectifier circuit. The zener diodes, D6 and D10, are optional components used to limit the peak voltage present at the node, Vin of U1, to within the requirements of the components attached to the node. The capacitors, C19 and C32, are anticipated to provide bulk capacitance for maintaining the voltage between rectification cycles. While two capacitors are shown in the current instantiation, one may be adequate or more than two required depending upon the components chosen. To prevent large input transients, it is desirable to have a low equivalent series resistance for the total capacitance at the node, Vin of U1. The capacitors, C43, C44, C46, and C47, are anticipated to be low ESR capacitors such as ceramics. The rationale for using both bulk capacitors and ceramics is that bulk capacitor technologies generally do not have adequate ESR for applications such as this while ceramic capacitors or other low ESR technologies do not have adequate total capacitance at the anticipated required voltage levels. Thus, the parallel combination of the two technology types represents a good approach for implementation.

The AC to DC converter 120 is anticipated to be a switching power supply that supplies a voltage output, VDC Out, at a max output current of I_{MAX} with a regulation efficiency of E. Thus, the power required to be supplied by the cable television system can be computed as:

$${P}_{source} = \frac{VDC Out * {I}_{MAX}}{ɛ} \qquad Eq . 3$$

Where: VDC Out is the AC to DC Converter 120 output voltage

I_{MAX} is maximum AC to DC Converter 120 output voltage

is the efficiency of the regulator.

P_{SOURCE} is the power to by supplied by the cable television system

With the voltage regulation circuitry designed for this instantiation of the present invention, the maximum current draw from the host cable system occurs when the host system has a minimum peak voltage. The minimum peak voltage (60 V) available from the potential AC voltage waveforms occurs when the voltage waveform is a 60 VAC square wave as determined previously. Thus, the minimum rectified voltage present at the node, Vin of U1, when the capacitors, C19 and C32 are fully charged is given by:

V_{in of U1}=60 V−V_{Zener}−I_{Source}*R16−0.7 V Eq. 4
Where: V_{in of U1} is the voltage present at the node, Vin of U1, when the capacitors, C19 and C32, are fully charged

V_{Zener} is the voltage drop across the Zener diodes, D6 and D10

I_{source}*R16 is the voltage drop across the resistor, R16

0.7 V is the estimated voltage drop across the diode, D5

Given the result of Eq. 4, the power required to be supplied by the cable television system can be written as:

P_{SOURCE}=(60 V−V_{Zener}−I_{Source}*R16−0.7 V)*I_{Source} Eq. 5

Equating the result of Eq. 5 to the result of Eq. 3 and solving for I_{Source} yields

$${I}_{source} = \frac{\begin{matrix}( 60 V - {V}_{Zener} - 0.7 V ) \pm \\ \sqrt{\begin{matrix}{( 60 V - {V}_{Zener} - 0.7 V )}^{2} - 4 * \\ R 16 * ( \frac{VDC Out * {I}_{MAX}}{ɛ} )\end{matrix}}\end{matrix}}{2 * R 16} \qquad Eq . 6$$

Where: I_{SOURCE} is the current that required to be supplied by the cable television system
   (60 V−V_{Zener}−I_{Source}*R16−0.7 V) is the voltage present at the node, Vin of U1, when the capacitors, C19 and C32, are fully charged
   R16 is the in-rush current suppression resistor
   VDC Out is the AC to DC Converter 120 output voltage
   I_{MAX} is maximum AC to DC Converter 120 output voltage
   ε is the efficiency of the regulator

The choice of V_{Zener} is determined by the reduction in the maximum peak voltage required to limit the voltage present at the node, Vin of U1, based upon the requirements of the components attached to this node. As shown in the discussion for FIG. 5, the maximum peak voltage would occur when the input AC power waveform is a sine wave. R16 is then chosen based upon the maximum current draw from the host cable television system for each installed instantiation of the present system. Eq. 7 is a restatement of Eq. 6 for the solution of R16 if the maximum current to be supplied by the cable television system is known.

$$R 16 = \frac{\begin{matrix}( 60 V - {V}_{Zener} - 0.7 V ) * {I}_{SOURCE} - \\ ( \frac{VDC Out * {I}_{MAX}}{ɛ} )\end{matrix}}{{( {I}_{SOURCE} )}^{2}} \qquad Eq . 7$$

During the negative half-cycle of the AC voltage signal, the voltage present at the node, Vin of U1, should not drop below a minimum voltage, Vₘᵢₙ, to avoid dropouts in the regulated voltage output, VDC Out. To determine the minimum bulk capacitance required to hold up the voltage above the Vₘᵢₙ threshold can be estimated by assuming that the rectifier load is approximately resistive. The minimum resistance of the rectifier load, Rₘᵢₙ coincides with the condition when the minimum peak voltage (60 V) available from the potential AC voltage waveforms occurs. Rₘᵢₙ can be determined as:

$${R}_{min} = \frac{( 60 V - {V}_{Zener} - 0.7 V ) - {I}_{SOURCE} * R 16}{{I}_{SOURCE}} \qquad Eq . 8$$

Where: Rₘᵢₙ is the modeled minimum resistance of the rectifier load
(60 V−V_{zener}−I_{Source}*R16−0.7 V) is the voltage present at the node, Vin of U1, when the capacitors, C19 and C32, are fully charged
R16 is the in-rush current suppression resistor
I_{SOURCE} is calculated current of Eq. 6

The bulk capacitance obtained by C19 and C32 is capable of holding up the voltage above Vₘᵢₙ during the negative voltage half-cycle under the minimum peak voltage condition given by a 60 VAC square wave input. Thus,

$${V}_{min} \leq ( 60 V - {V}_{Zener} - {I}_{Source} * R 16 - 0.7 V ) * {e}^{\frac{- t}{{R}_{min} * ( C 19 + C 32 )}} \qquad Eq . 9$$

Where: Vₘᵢₙ is the minimum voltage present at the node, Vin of U1, to avoid dropouts in the regulated voltage output, VDC Out.
   (60 V−V_{zener}−I_{Source}*R16−0.7 V) is the voltage present at the node, Vin of U1, when the capacitors, C19 and C32, are fully charged
   t is time
   Rₘᵢₙ is the modeled minimum resistance of the rectifier load
   C19+C32 is the bulk capacitance

Using 1/120^{th of a second as the time duration of the negative half cycle of the voltage waveform and solving for the bulk capacitance, C19+C32 yields}

$$C 19 + C 32 = \frac{- 1}{\begin{matrix}ln ( \frac{{V}_{min}}{60 V - {V}_{Zener} - {I}_{Source} * R 16 - 0.7 V} ) * \\ {R}_{min} * 120\end{matrix}} \qquad Eq . 10$$

The regulator circuit in the instantiation of the present invention may use a regulator controller commercially-available from Linear Technologies with model number LTC3703, which is U1 of FIG. 7. This is a synchronous step-down switching regulator controller that can directly step-down voltages from 100V and drives external N-channel MOSFET's using a constant frequency, voltage mode architecture. A precise internal reference provides 1% DC voltage output accuracy. A high bandwidth error amplifier and line feed forward compensation provide very fast line and load transient response. Strong gate drivers allow the LTC3703 to drive multiple MOSFETs for higher current applications. The operating frequency is user programmable from 100 kHz to 600 kHz and can also be synchronized to an external clock for noise-sensitive applications. Current limit is programmable with an external resistor and utilizes the voltage drop across the synchronous MOSFET to eliminate the need for a current sense resistor.

The optional components, C121, C119, C122, C120, and L73, form a pi filter to increase the noise immunity and transient suppression of the LTC3703 regulator.

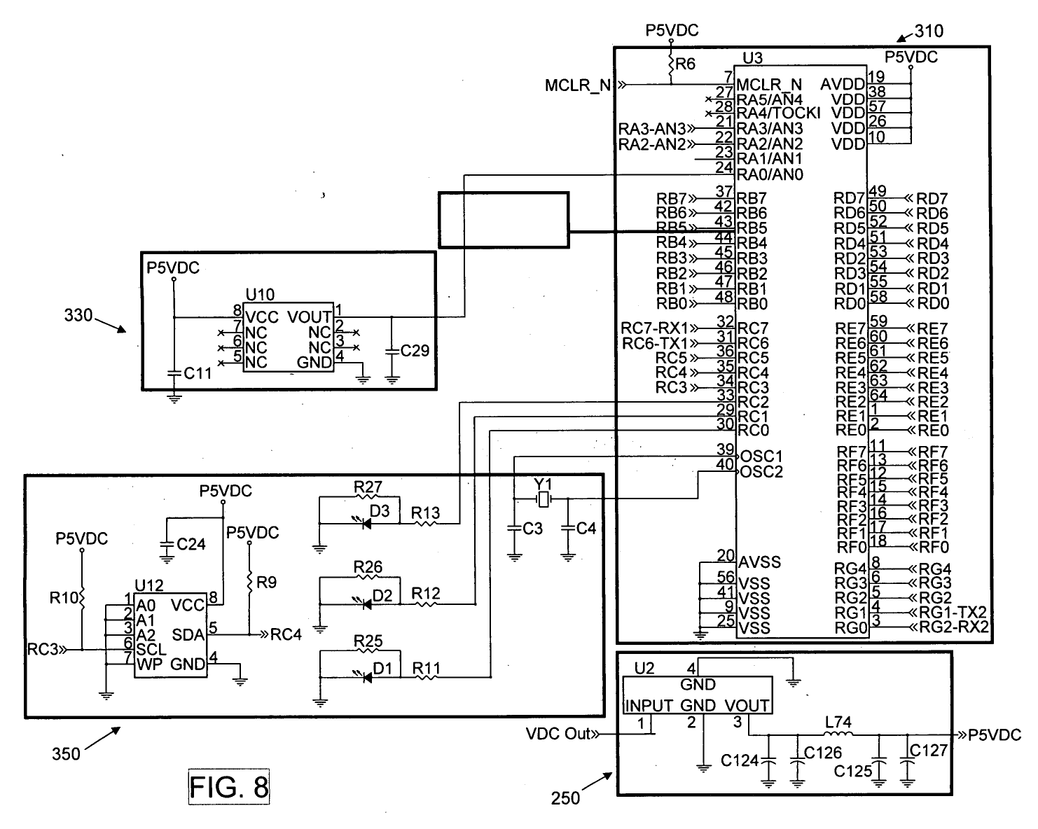

FIG. 8 is a detailed schematic of an instantiation of the microprocessor 310, the temp sensor 330, the DC to DC converter 250, and the microprocessor support electronics 350.

U10, C11, and optional C29 in this embodiment represent the temperature sensor 330 components. U10 is a broad range precision temperature sensor whose output voltage is linearly proportional to the temperature, such as the LM34 by National Semiconductor. The temperature sensor device in this instantiation has an analog output whose voltage level is linearly proportional to the Fahrenheit temperature and is be connected to one of the internal analog to digital converter inputs of the microprocessor 310. This instantiation has an advantage over linear temperature sensing circuits calibrated in degrees Kelvin in that a large constant voltage is not required to be subtracted from its output to obtain conventional Fahrenheit scaling. The capacitor, C11, is a power supply de-coupling capacitor while the optional capacitor, C29, may help enhances noise immunity on the analog signal line.

The components U12, R10, C24, R9, R27, D3, R13, R26, D2, R12, R25, D1, R11, Y1, C3, and C4 represent the microprocessor support electronics 350 for the instantiation of the present invention.

The microprocessor support electronics 350 includes the power-up reset logic for the microprocessor 310, LED's, crystal oscillator circuits to provide a time reference for the microprocessor 310, digital memory, and other parts. A temperature sensor 330 allows the microprocessor 310 to report the temperature environment of the controller module with security device 100 to the web-based software 10 of FIG. 1. D3, R27, and R13 form a light-emitting diode (LED) circuit. The light emitting diode, D3, can be turned on or off by the microprocessor 310 and acts as visual indication of the state of the dynamic host configuration protocol (DHCP) when the controller module 500 is requesting an internet protocol (IP) address. When the microprocessor 310 output is a TTL high or ‘1’, the LED will be on and when the microprocessor output is a TTL low or ‘0’, the LED will be off. In the present instantiation, the LED, D3, is solid if DHCP is ready and will blink if a failure has occurred. The function of the LED, D3, can be changed by changing the microprocessor 310 software.

D2, R26, and R12 form another light-emitting diode circuit. In the present instantiation, D2 will blink every 15 seconds to visually signal that the microprocessor 310 software is operating normally. The function of the LED, D2, can be changed by changing the microprocessor 310 software.

D1, R25, and R11 form a third light emitting diode circuit as part of the microprocessor support electronics 350. In the present instantiation, D1 is on to signal that external communications with a peripheral device such as the security camera 1000 is operating normally. The function of the LED, D1, can be changed by changing the microprocessor 310 software.

Y1, C3, and C4 form the clock oscillator circuit for the microprocessor 310. Y1 is a crystal oscillator such as an HCM49-10.000MAJB-UT, 10 MHz oscillator by Citizen America. The oscillator serves as the timing reference for the microprocessor 310. Capacitors, C3 and C4, serve as optional load capacitance to the crystal.

The components U2, C124, C126, L74, C125, and C127 represent the DC to DC converter 250 of the instantiation of the present invention. U2 is a 3-terminal regulator, such as a μA78M05 by Texas Instruments, designed to step-down the voltage from VDC Out to +5 VDC. The components C124, C126, L74, C125, and C127 form a pi filter to provide enhanced noise suppression to the +5 VDC output from the regulator.

The component U3 represents the microprocessor 310 of the instantiation of the present invention. The microprocessor 310 of the instantiation of the present invention has serial communication ports, parallel ports for direct processor interface, self-programmability meaning that the device can write to its own program memory spaces under direct software control, and built-in analog to digital conversion ports. A device meeting these characteristic requirements is the PICF6627 by Microchip Technology.

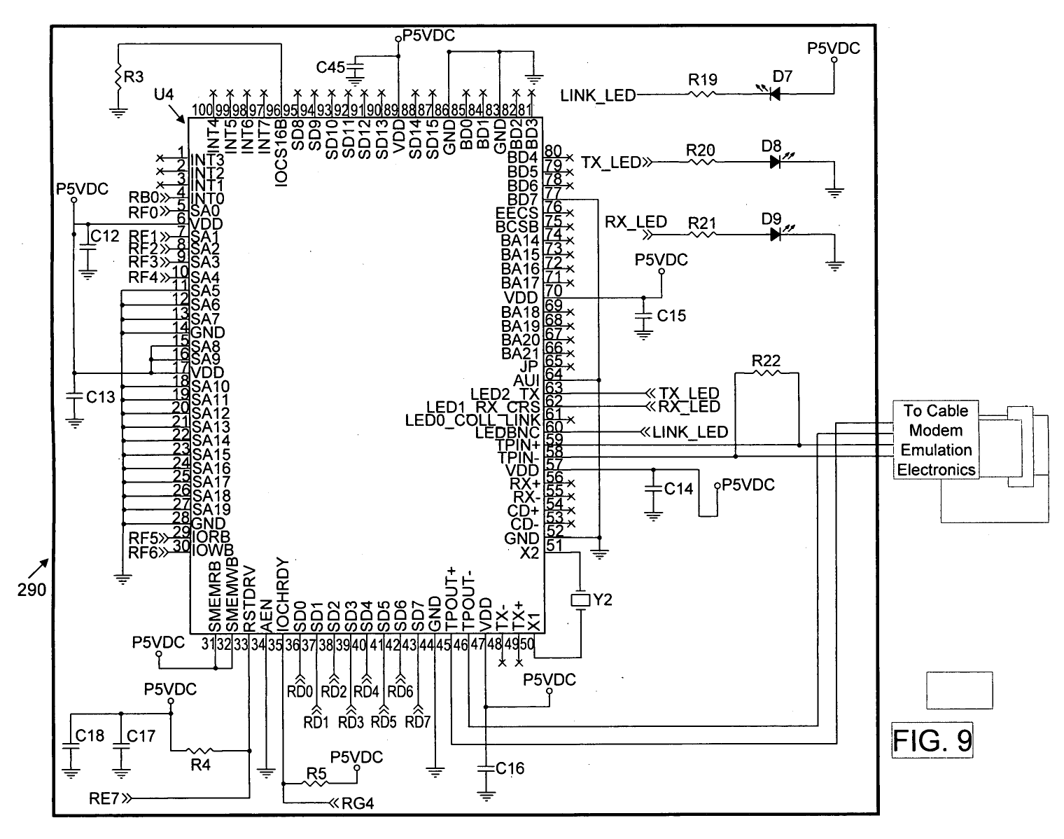

FIG. 9 is a detailed schematic of the instantiation of the optional communication controller 290 of the controller module. U4 is an Ethernet controller, such as the RTL8019AS by the microprocessor 310 bus. Use of an Ethernet controller allows the present instantiation to use existing, commercially-available cable modems such as the Webstar DPC2100R2 series cable modem from Scientific Atlanta. Optional light emitting diode circuits represented by R19, D7, R20, D8, R21, and D9 allow visual indication of the link status, transmit activity, and receive activity for the Ethernet controller.

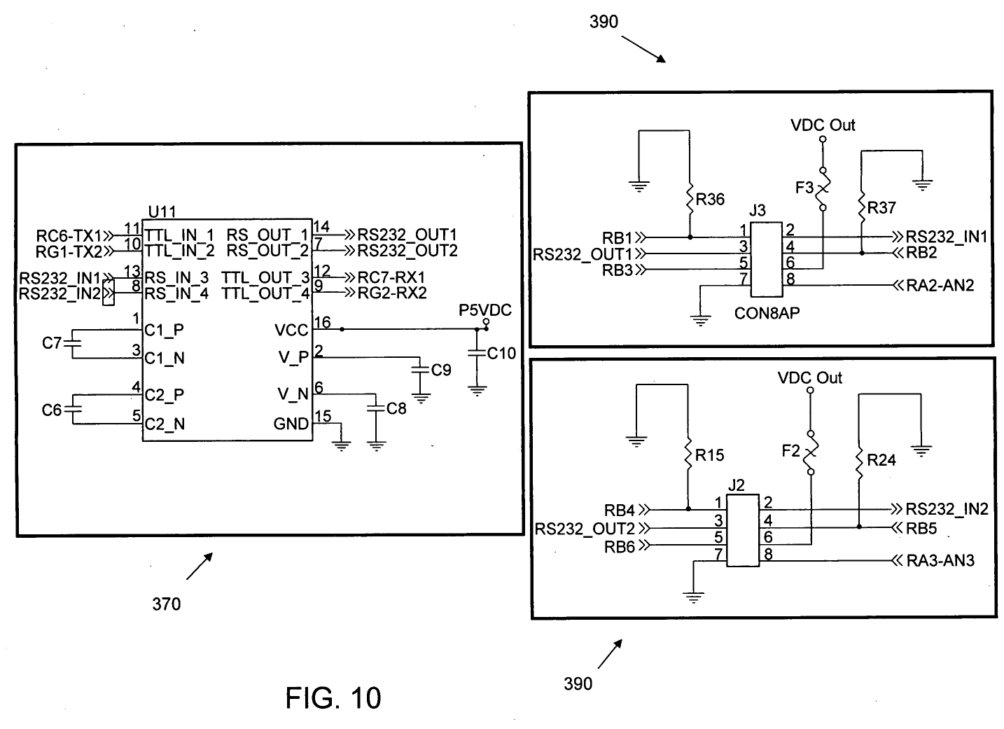

FIG. 10 is a detailed schematic of the instantiation of the serial TX/RX 370 function and the output connect 390. In the present instantiation, two output connectors 390 are implemented. The serial TX/RX 370 function of the instantiation of the present invention translates TTL serial information into RS-232 signaling for transport to peripheral devices such as the security camera 1000. A device such as the LT1381CS by Linear Technology will accomplish the requirements of the serial TX/RX 370 function. The output connectors 390 provide the necessary serial communication, analog signaling, digital bus connections, power, and ground to operate peripheral devices. The power signal, VDC Out, is connected to the output connector 390 through a positive temperature coefficient fuse, F2 and F3, to avoid damaging the controller module 500 circuitry due to an over-current condition in a peripheral device.

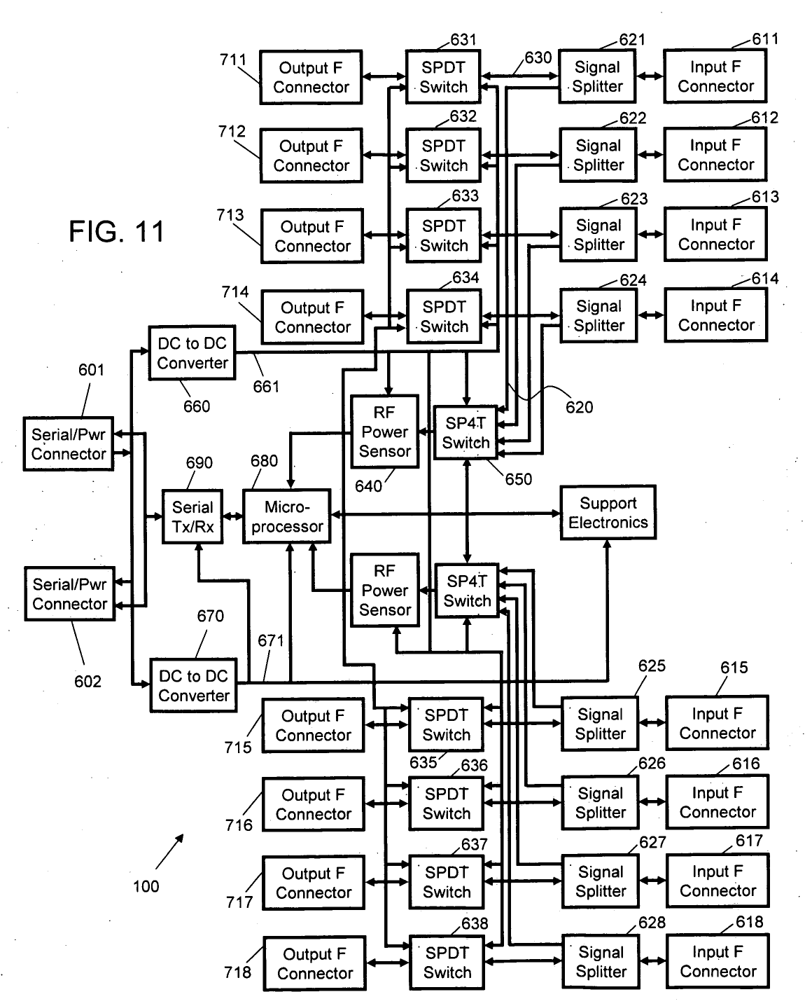

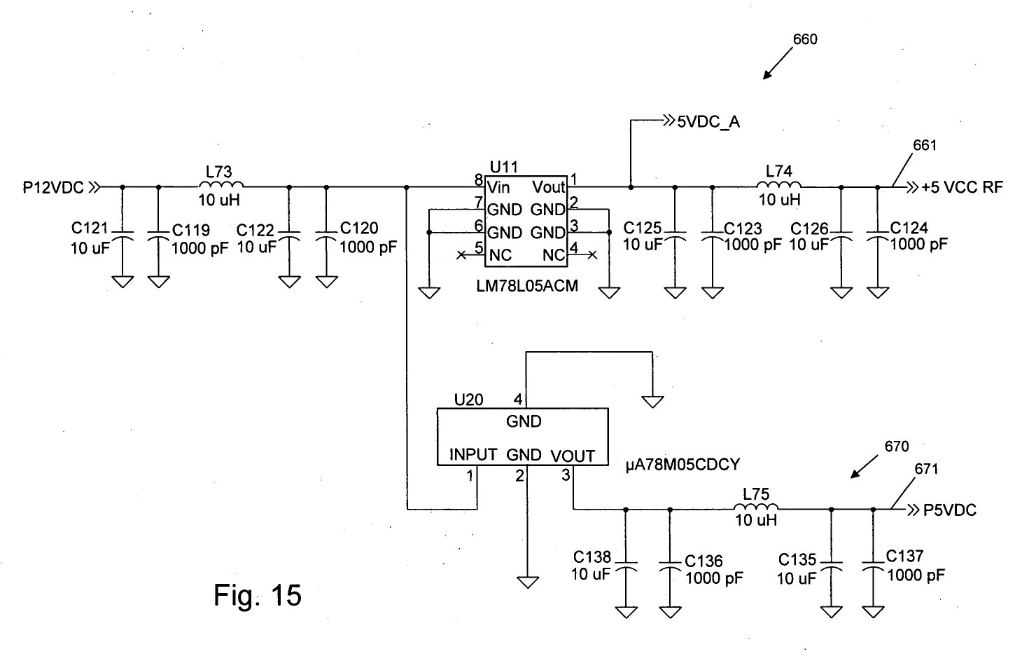

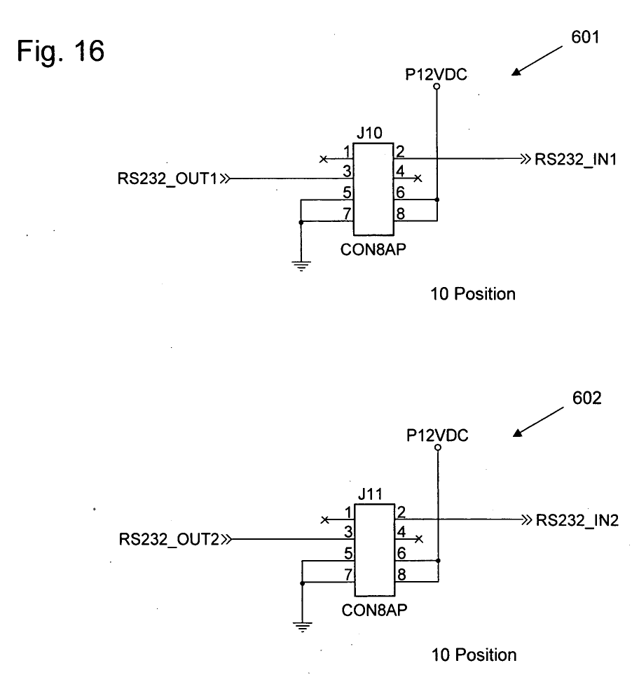

FIG. 11 shows a eight port switch module 100. Two serial/power connectors 601, 602 are provided, one of which is connected to the output connector 390 of the controller module 500 of FIG. 4. The other connector can be used for connection to a further switch module. The switch module 100 of FIG. 11 is designed to accommodate eight independent ports per device primarily due to the prevalence of eight port taps in the cable network, but could be more or less based upon the CATV providers wishes. However, four port switch modules as shown in FIG. 2 are also possible, and may be connected in series. One instantiation of the connectors 601, 602 is shown in FIG. 16.

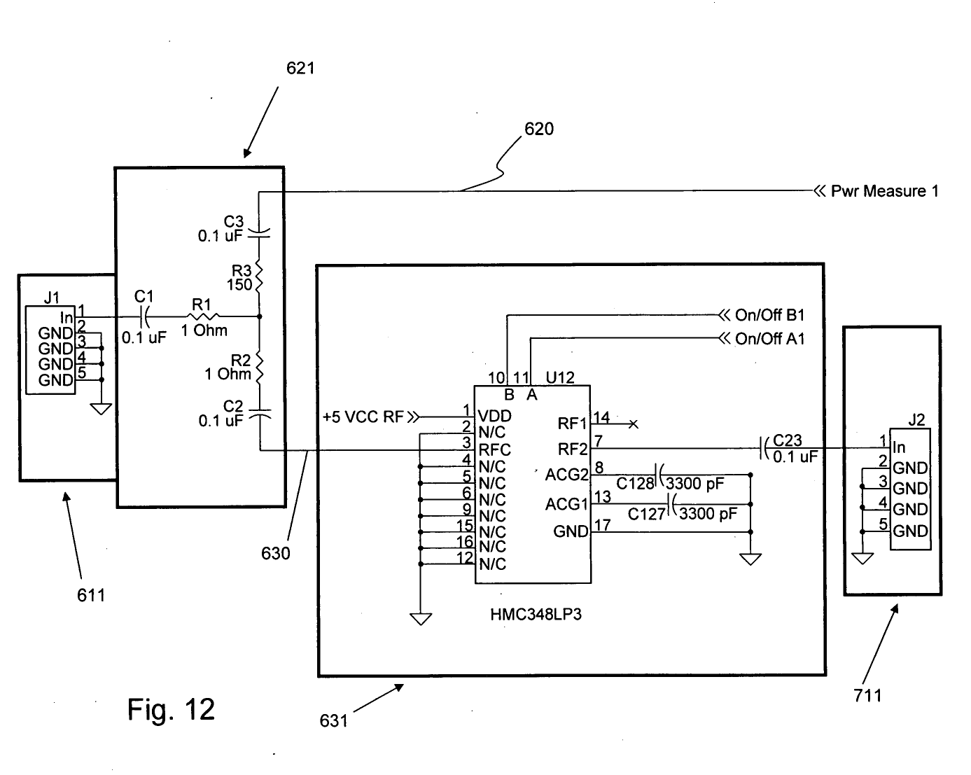

Switch module 100 is used to program automated service connects and disconnects for primarily bulk applications in the CATV network. In this embodiment, up to eight manual input connectors 611, 612, 613, 614, 615, 616, 617, 618 are provided, for example for each port of an eight port signal tap. Each input connector 611 to 618 can connect to a signal splitter 621, 622, 623, 624, 625, 626, 627, 628, a single pole double throw (SPDT) switch 631, 632, 633, 634, 635, 636, 637, 638, and an output connector 711, 712, 713, 714, 715, 716, 717, 718, respectively. One instantiation of the input connector 611, signal splitter 621, SPDT switch 631 and output connector 711 is shown in FIG. 12. The switch 631 for example may be a SPDT HMC348LP3 switch commercially-available from the Hittite Microwave Corporation. It should be understood that all of the input connectors 611 to 618, signal splitters 621 to 628, SPDT switches 631 to 638 and output connectors 711 to 718 may be similar to this instantiation.

The signal input connectors may be F connector jacks compatible with existing CATV network patch cables. The F connector is capable of passing the entire RF spectrum of 5′MHz to 850 MHz for cable network operations. Each output of the input connectors 611 to 618 feeds a respective signal splitter 621 to 628. The signal splitters are designed to send approximately 1/10th of the signal power to an RF power sensor circuit 640 via a line 620 and switch 650 to allow the switch module 100 to sense whether or not the input cables are connected properly to each port. The other output 630 of the signal splitter is a low loss (approximately −0.5 dB) path that feeds a respective switch 631 to 638 that acts as the connect/disconnect mechanism. The output of the SPDT switch feeds to another output F connector 711 to 718 respectively that will connect to the drop cable going to the customer premise.

The input connectors 611 to 618 may be compatible with locking connectors requiring a special tool to remove the connection.

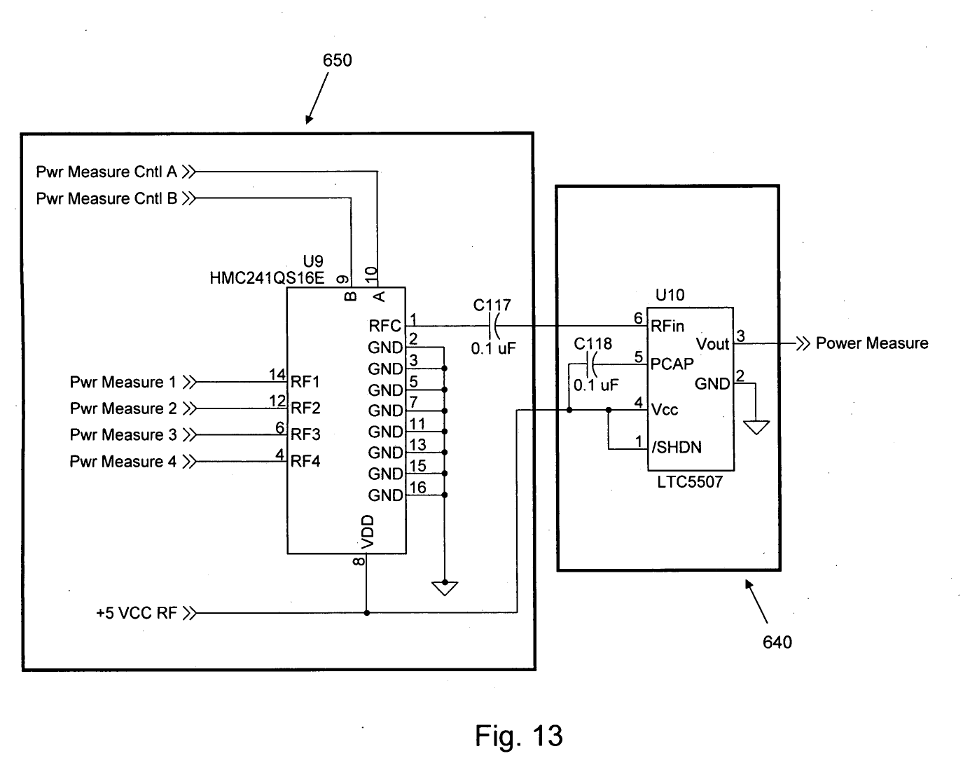

Power measurement line 620, switch 650 and RF power sensor 640 are implemented to verify that the manual tap outputs are connected properly to make it difficult to steal cable by disconnecting the switch module. This RF power sensor circuit is designed to provide an analog voltage corresponding to a measurement of the input power. The input to the RF power measurement circuitry is accommodated via two single-pole, four throw (SP4T) switches 650 to individually direct each port input to the RF power sensor 640. FIG. 13 shows one possible instantiation for switch 650 and power sensor 640. Switch 650 may include for example an SP4T switch model HMC241QS16E commercially-available from the Hittite Microwave Corporation. Switch 640 may include a power detector model LTC 5507 commercially-available from Linear Technology.

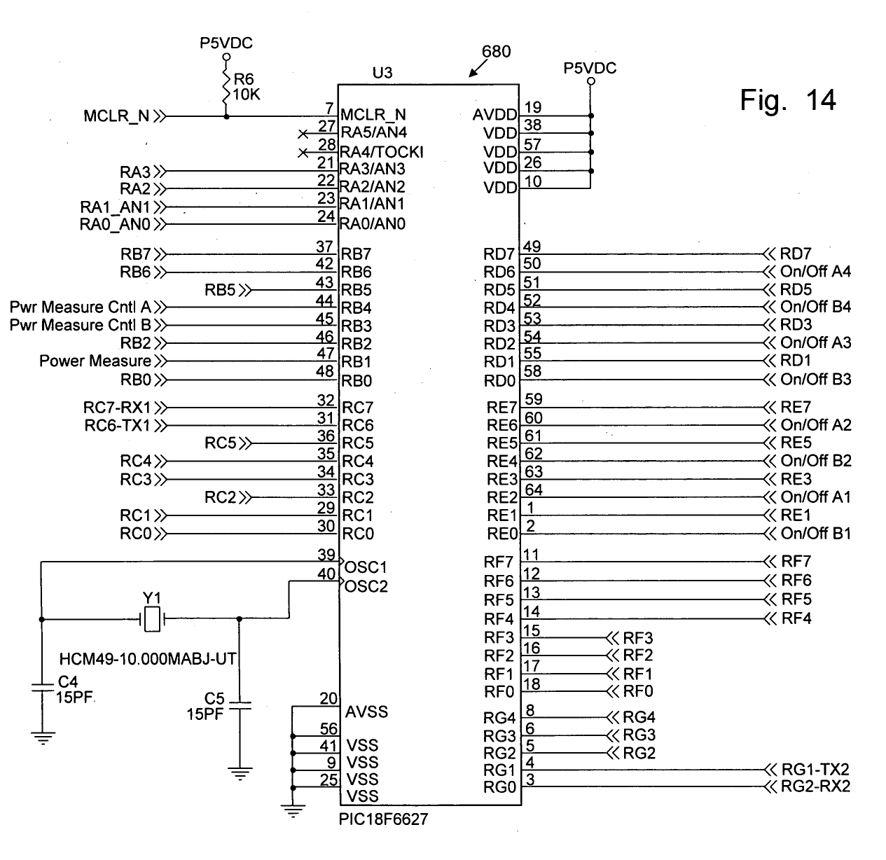

Microprocessor 680 may be one commercially-available from Microchip Technology with model number PIC18F6627, as shown in FIG. 14. Alternately, microprocessor 680 could be replaced by an ASIC or other hardwired logic without software. Microprocessor 680 receives inputs and outputs from a serial transmitter receiver 690 and support electronics 695. Microprocessor 680 acts as the communication and control element. Messages or data sent from the controller module 500 are received by microprocessor 680 and the appropriate commands are executed or data/measurements sent back to the controller module 500 through the serial transmitter/receiver 690.

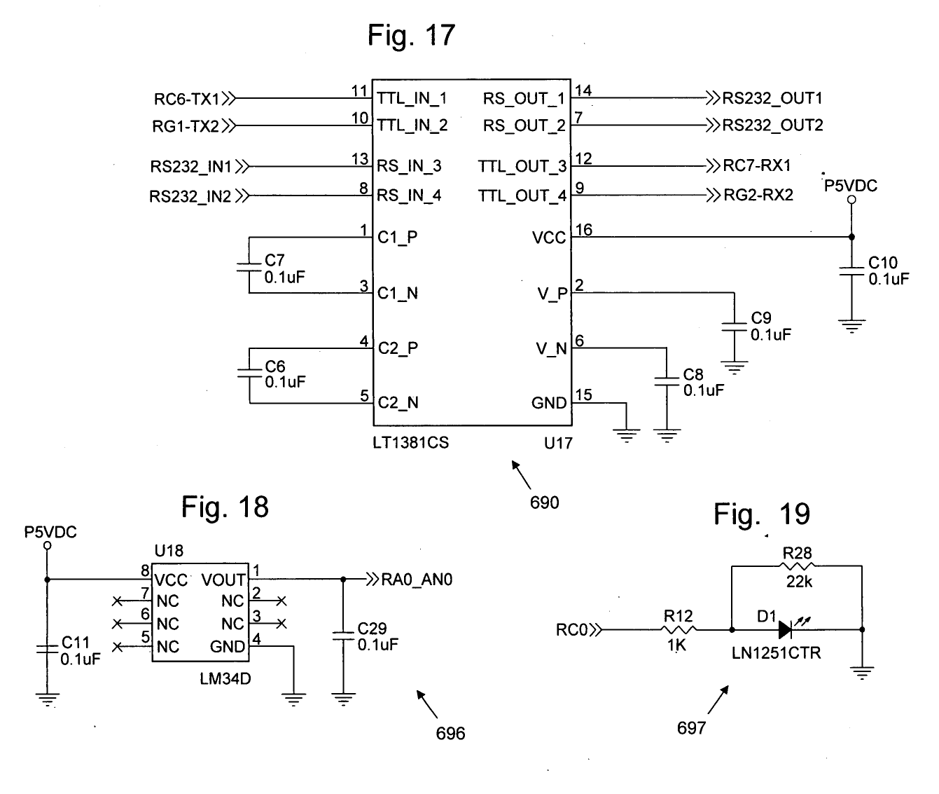

One instantiation of transmitter/receiver 690 is shown in FIG. 17, and may include a driver receiver commercially-available from Linear Technology with model number LTI381CS. The serial Tx/Rx 690 allows the switch module 100 to communicate with the controller module 500. Each switch module has a unique identifier (similar to a MAC address) that is used to identify the appropriate device. This allows multiple switch modules to be connected to a single controller module as shown in FIG. 2 without creating addressing conflicts and potential control problems. Additionally, all communications between a switch module and the controller module can be initiated by the controller module 500 to minimize communication clashes that may occur on the serial communications lines by multiple devices attempting to transmit at the same time.

Support electronics 695 includes the power-up reset logic for the microprocessor, LED's, crystal oscillator circuits, and temperature sensing to monitor the temperature of the switch module 100. FIG. 18 shows for example a temperature sensor 696 commercially-available from National Semiconductor, and FIG. 19 a light-emitting diode commercially-available from Panasonic. Electronics 695 may also include a crystal oscillator such as an HCM49-10.000MAJB-UT, 10 MHz oscillator by Citizen America

The switch module using the power sensor 640 can sense whether or not the input ports are connected. All tap ports typically are connected to a switch module in a given installation environment using switch modules even if there are more tap ports than customers. By connecting the tap port output to a switch module input as shown in FIG. 2, the service to a customer can controlled through the functions of the switch module. For a non-paying customer who is disconnected by the switch module to ‘steal’ the signal from the cable company, the thief would have to disconnect' the cable going to his premise from the output of the switch module and also disconnect the input to the switch module to reconnect his premise cable directly to the tap, assuming that all tap outputs are connected to a switch module input. By measuring the input power for each port input, the switch module can recognize the change in connectivity state and alert the cable television provider to the possibility of cable theft.

DC to DC converters 660, 670 shown in FIG. 15 are designed to convert the +12V DC input from the controller module 500 to +5V DC to power the devices within the switch module 100. Separate converters 660, 670 and supply lines 661, 671 for the RF and digital electronics, respectively, help ensure the minimization of digital switching noise corrupting the RF signal integrity.

Controller module 500 can be set to provide information on the status of the switch modules at preset times, for example each night at 2 am, or at preset intervals, for example every hour, to the head end 25. Cable modem 200 provides the information over normal cable modem frequencies. The controller module can also provide the status information in response to a query from the head end 25.

The switching devices of the present invention advantageously can be used to update an existing cable system by simply attaching to existing cable signal taps.

1-24. (canceled)

25. A device for controlling cable signals between a network cable and drop cables to customers comprising:
an input for receiving cable signals;
a first output connector for sending the cable signals to a first customer;
a second output connector for sending the cable signals to a second customer;
a circuit selectively connecting the input to the first output connector so as to permit or deny a provision of all of the cable signals to the first customer, and selectively connecting the input connector to the second output connector to permit or deny provision of all of the cable signals to the second customer;
a cable modem, the cable modem capable of receiving instructions via the input and sending information via the input, and
a power sensor to sense a connection status to the first customer and the second customer.

26. The device as recited in claim 25 wherein the electronics include a first switch between the input and the first output and a second switch between the input and the second output.

27. The device as recited in claim 26 wherein the electronics includes a microprocessor controlling the first switch and the second switch.

28. The device as recited in claim 26 wherein the electronics include a first signal splitter connected to the first switch and the first output connector and a second signal splitter connected to the second switch and the second output connector.

29. The device as recited in claim 25 wherein the cable modem has a media access control address.

30. The device as recited in claim 25 wherein the electronics including a signal splitter and an AC-DC converter receiving an input from the signal splitter.

31. The device as recited in claim 25 wherein the electronics includes a switch module and a controller module, the controller module including an AC-DC converter.

32. The device as recited in claim 31 wherein the electronics include a cable between the switch module and the controller module.

33. A control system for a cable network comprising:
a plurality of electronically-controlled devices, each device being as recited in claim 25 and being located between the network cable and the plurality of drop cables for customers and each having a media access control address, and
a server for controlling the electronically-controlled devices, the server selectively enabling provisioning of cable service to each customer.

34. The device as recited in claim 25 wherein the input includes an input connector carrying a composite RF and AC signal.

35. The device as recited in claim 34 further comprising a signal splitter the composite RF and AC signal into an RF signal and an AC signal.

36. The device as recited in claim 35 further comprising an AC to DC converter receiving the AC signal and converting a 60 Hz AC square wave of the signal into a DC voltage.

37. The device as recited in claim 25 wherein the circuit includes a power up reset logic for a microprocessor.

38. The device as recited in claim 25 further comprising a temperature sensor connected to the circuit.

39. The device as recited in claim 25 wherein the input includes an input connector including a printed circuit board mounted F connector.

40. The device as recited in claim 35 wherein the signal splitter includes a PTC fuse.
